(19) United States
(12) Patent Application Publication
(10) Pub. No.: US 2009/0033009 A1
(43) Pub. Date: Feb. 5, 2009

(54) Self-pumping hydropneumatic spring-damper unit

(75) Inventors: Holger Kirchner, Ruppichteroth (DE); Klaus Schmitz, Eitorf (DE); Hubert Beck, Eitorf (DE)

Correspondence Address: COHEN, PONTANI, LIEBERMAN & PAVANE LLP, 551 FIFTH AVENUE, SUITE 1210, NEW YORK, NY, 10176, US

(73) Assignee: ZF Friedrichshafen AG, Friedrichshafen (DE)

(21) Appl. No.: 12/221,222

(22) Filed: Jul. 31, 2008

(30) Foreign Application Priority Data
Aug. 1, 2007 (DE) 10 2007 036 102.7

(51) Int. Cl. F16F 9/18

(52) U.S. Cl. 267/124

(57) ABSTRACT

A self-pumping hydropneumatic spring-damper unit with internal leveling control is provided. The spring-damper unit has an oil-filled work cylinder under pressure by gas cushions. A damping piston is displaceable in the work cylinder and arranged at the end of a hollow piston rod whose hollow space serves to receive a pump by means of a pump rod fastened to the work cylinder. Damping medium is sucked out of a reservoir space when the piston rod moves outward and is conveyed into the work space when the piston rod moves inward. The pump rod has a control opening and, at a distance therefrom, an outlet bore for pressure equilibrium between work spaces in the work cylinder. At least one pressure-dependent throttle point is provided in the pump space between the high-pressure and low-pressure gas cushions. A first flow connection in the pump rod provided with at least one check valve connects the low-pressure gas cushion to the pump space. A second flow connection having the throttle point is connected to the work space by the outlet bore.

### BACKGROUND OF THE INVENTION

1. Field of the Invention

The invention is directed to a self-pumping hydropneumatic spring-damper unit with internal leveling control.

2. Description of the Related Art

Self-pumping hydropneumatic spring-damper units with internal leveling control are already known (DE 10 2004 009 224 B3), wherein the damping piston is arranged in a work cylinder so as to be displaceable axially. This damping piston is under pressure by a high-pressure gas cushion and a low-pressure gas cushion. The damping piston is arranged at the end of a hollow piston rod, which has a hollow space designed as a pump space. A pump rod is located inside the pump space and fastened to the work cylinder projecting into the hollow piston rod. Oil is sucked out of the low-pressure chamber when the piston rod moves outward. Oil is conveyed into the work space when the piston rod moves inward. When the vehicle level height is exceeded or during spring rebound, an outlet bore is released so that a pressure equilibrium comes about inside the spring-damper unit. The actual throttle is constructed as a bypass, wherein the throughflow of oil from the high-pressure space to the low-pressure space is defined by a predetermined cross section. With a constant cross section of this kind, the amount of oil that flows through is highly dependent upon pressure, which is undesirable in principle.

### SUMMARY OF THE INVENTION

It is an object of the invention to provide a self-pumping hydropneumatic spring-damper unit with an internal leveling control in which the amount of oil flowing through the throttle bore is dependent upon pressure. The cross section of the throttle is smaller at high pressures than at low pressures.

More specifically, the self-pumping hydropneumatic spring-damper unit according to an embodiment of the present invention comprises an oil-filled work cylinder under pressure by gas cushions and a damping piston displaceable in the work cylinder at the end of a hollow piston rod. The hollow piston rod as a hollow space for receiving a pump by means of a pump rod that is fastened to the work cylinder. Oil is sucked out of a reservoir space when the piston rod moves outward and is conveyed into the work space when the piston rod moves inward. A control opening and, at a distance therefrom, an outlet bore in the pump rod are provided for pressure equilibrium between the work spaces. At least one pressure-dependent throttle point is provided in the pump space between the high-pressure gas cushion and the low-pressure gas cushion. A first flow connection in the pump rod is provided with at least one check valve. The first flow connection connects the low-pressure gas cushion to the pump space. A second flow connection having the throttle point is connected to the work space by the outlet bore.

The two flow connections can be provided with different flow resistances (throttles) by separating the flow connections from the low-pressure gas cushion via the check valve to the pump space and from the work space via the outlet bore to the low-pressure space. The second flow connection is advantageously throttled in such a way that the inside wheel with respect to cornering lets as little oil as possible flow back into the low-pressure space during a temporary spring rebound or when cornering.

In one embodiment of the invention, a filter element is arranged in at least one of the flow connections.

According to another embodiment, the throttle point is arranged in an element which is arranged in the flow connection so as to be axially displaceable in a pressure-dependent manner. To shape the variable outlet cross section (throttle point), the throttle point may be provided with a fixed throttle cross section which is arranged so as to be axially displaceable. The element is preferably constructed to be cylindrical.

According to another embodiment, the element is acted upon by a spring force on the front side opposite to the high-pressure gas cushion. A mechanical and/or gas spring can be provided as the spring force.

The fixed throttle point may, for example, be a bore hole, notch, or groove.

In another construction, the element has on its outer circumference at least one seal that seals relative to the inner wall of the flow connection.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

Preferred embodiment examples of the invention are shown schematically in the drawings.

FIG. 1 is a sectional view showing a self-pumping hydropneumatic spring-damper unit with internal leveling control; and

FIGS. 2 and 3 show detailed views of the area of two flow connections together with the throttle point.

### DETAILED DESCRIPTION OF THE EMBODIMENTS

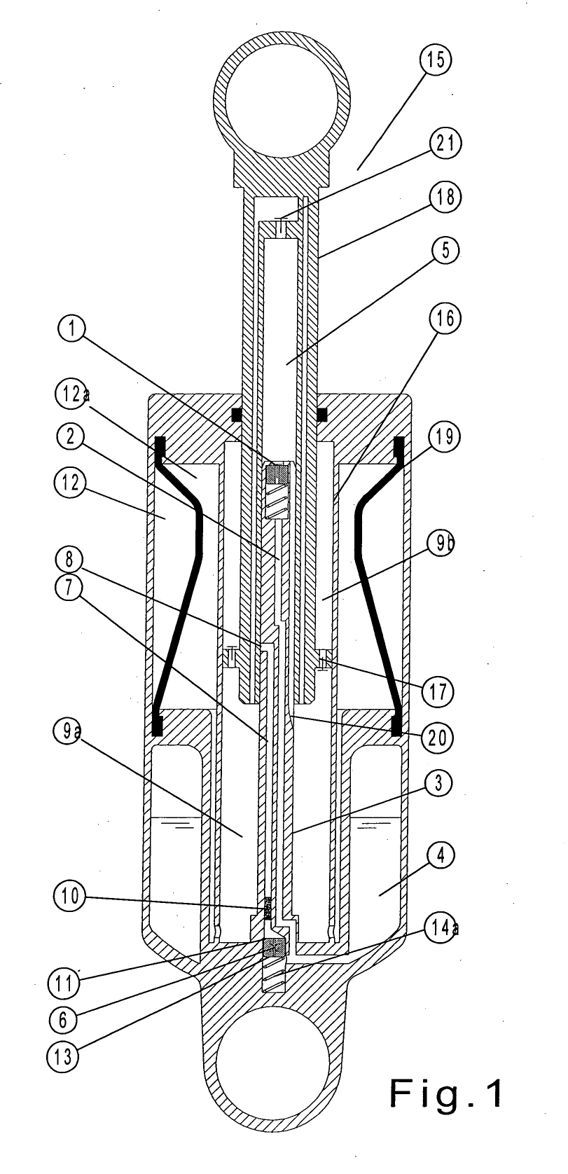

The self-pumping hydropneumatic spring-damper unit 15 for motor vehicles shown in FIG. 1 substantially comprises a work cylinder 16, in which a damping piston 17 slides. The damping piston 17 is formed at the end of a hollow piston rod 18. The work cylinder 16 is closed off on one side by an end wall and on the other side by the piston rod guide, through which the hollow piston rod 18 passes outward in a sealed manner. The spring-damper unit 15 is fastened by the end wall to the body of a vehicle (not shown) by a fastening eye, and at the other end of the spring-damper unit 15, the piston rod 18 is fastened to the axle of the vehicle by means of another fastening eye in a known manner. The work cylinder 16 is surrounded by an annular compensation chamber which is filled partly with oil and partly with gas. This compensation chamber is divided by an intermediate wall into a high-pressure gas cushion 12 and a low-pressure gas cushion 4. The high-pressure gas cushion 12 in the high-pressure chamber is separated from an oil space 12a by a dividing wall 19. In the fully limited state, that is, without any elevation in pumping, the pressure in the low-pressure gas cushion 4 is the same as that in the high-pressure gas cushion 12.

The low-pressure gas cushion 4 and the oil space 12a of the high-pressure gas cushion 12 are both communicated with the work cylinder 16. The work cylinder 16 is divided by the damping piston 17 into two work spaces 9a, 9b. The damping piston 17 has damping valves for the pull stage and the push stage.

The actual leveling control of the self-pumping hydropneumatic spring-damper unit 15 is carried out by the pump rod 3, which cooperates with the hollow piston rod 18 to form a pump. During the operation of the vehicle, the relative movement between the pump rod 3 and the hollow piston rod 18 causes damping medium to be conveyed from the low-pressure gas cushion 4 into the work spaces by way of valves. In doing so, the damping piston 17 is moved outward until a bypass 20 produces a connection between the pump space 5 and the bottom work space 9a.

At this point, the pumping action of the pump is suppressed, and the dynamic level height of the vehicle is reached. When the load is removed from the vehicle, the damping piston 17 initially continues to be pushed outward by the high-pressure gas cushion 12 until a pressure equilibrium comes about inside the spring-damper unit 15 via the outlet bore 8 which has now been opened. Subsequently, the hollow piston rod 18 with the damping piston 17 is pushed inward.

The outlet bore 8 is connected to the low-pressure gas cushion 4 by a second flow connection 7 and a throttle point 6.

The pumping action, which results from the relative movement of the vehicle body during the operation of the vehicle and the resulting pumping of damping medium from the low-pressure gas cushion 4 into the work spaces, proceeds from the low-pressure gas cushion 4 via a first flow connection 2, past the check valve 1 into the pump space 5 and then, via a check valve 21, into the lower work space 9a.

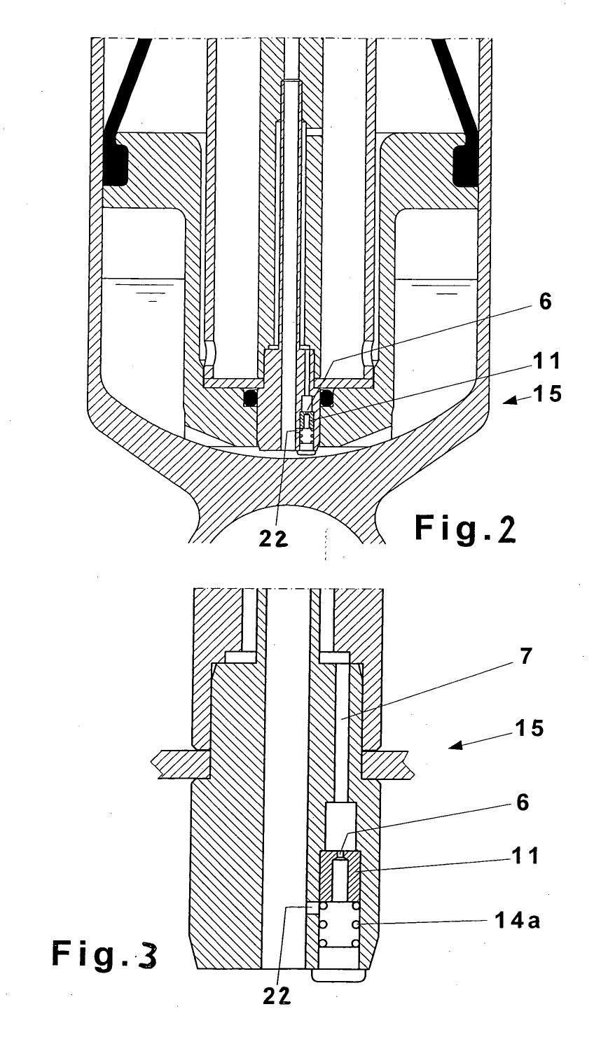

In order to vary the shape of an outlet cross section, a throttle point 6 with a fixed cross section is arranged in an element 11. This element 11 slides in the second flow connection 7 of the pump rod 3. When the damping medium flows from the high-pressure gas cushion 12 and the associated oil space 12a in direction of the low-pressure gas cushion 4, the element 11 is moved in direction of the low-pressure gas cushion 4 in the second flow connection 7 and, in doing so, passes over corresponding control openings 22 (FIGS. 2 and 3) in the pump rod 3. In this way, the connection of the second flow connection 7 to the low-pressure gas cushion 4 is interrupted. The oil pressure on both sides of the element 11 is equalized through the cross section of the throttle point 6. When the pressure is equalized, a spring force of a mechanical spring 14a acting on a front side 13 of the element 11 moves the element 11 in a direction toward the high-pressure gas cushion 12, so that oil can again flow into the low-pressure gas cushion 4. There is now an equilibrium between the pressure differences and the spring force 14.

In addition, a filter element 10 can be received in the flow connection 7 to protect the throttle point 6 against blockage and impurities.

FIGS. 2 and 3 show detailed views of the lower area of a spring-damper unit 15, wherein the element 11 is arranged in the second flow connection 7 together with the throttle point 6 and the mechanical spring 14a. Depending on the pressure acting on the element 11, the control openings 22 can be closed or opened through the axial displacement of the element 11. When the control openings 22 are opened the high-pressure gas cushion 12 or associated oil space 12a is connected to the low-pressure gas cushion 4.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A self-pumping hydropneumatic spring-damper unit with internal leveling control, the spring-damper unit comprising:
a work cylinder filled with a damping medium and under pressure by high-pressure and low-pressure gas cushions;
a hollow piston rod having a free end;
a damping piston at the free end of the piston rod and displaceable in the work cylinder, the damping piston dividing the work cylinder into two work spaces;
a pump rod fastened to the work cylinder and received in the hollow piston rod, the pump rod and the piston rod defining a pump space in the piston rod, the pump rod having a control opening and, at a distance therefrom, an outlet bore for pressure equilibrium between the work spaces in the work cylinder; and
at least one pressure-dependent throttle point arranged between the high-pressure gas cushion and the low-pressure gas cushion,
wherein the pump rod forms a first flow connection with at least one check valve connecting the low-pressure gas cushion to the pump space, and
wherein the pump rod has a second flow connection with a throttle point between the high-pressure and low-pressure gas cushions, and the second flow connection is connected to the work spaces by an outlet bore of the second flow connection.

2. The spring-damper unit according to claim 1 further comprising a filter element arranged in at least one of the first and second flow connections.

3. The spring-damper unit according to claim 1, wherein the throttle point is arranged in an element arranged in the second flow connection so as to be axially displaceable in a pressure-dependent manner.

4. The spring-damper unit according to claim 3, wherein the element is acted upon by a spring force on a front side opposite to the high-pressure gas cushion.

5. The spring-damper unit according to claim 4, wherein the spring force is provided by one of a mechanical spring or gas spring.

6. The spring-damper unit according to claim 1, wherein the throttle point comprises at least one of a bore hole, a notch, and a groove in an element arranged in said at least one of said first and second flow connections.

7. The spring-damper unit according to claim 4, wherein the element has on its outer circumference at least one seal that seals relative to an inner wall of the second flow connection.

8. The spring-damper unit according to claim 1, wherein the piston rod is configured to move outward to draw the damping medium out of a reservoir.

9. The spring-damper unit according to claim 1, wherein the piston rod is configured to move inward to return the damping medium into the work space.
